(19) United States
(12) Patent Application Publication
(10) Pub. No.: US 2025/0377881 A1
(43) Pub. Date: Dec. 11, 2025

(54) METHOD, DEVICE, AND PRODUCT FOR UPDATING APPLICATION PROGRAMMING INTERFACE (API)

(71) Applicant: DELL PRODUCTS L.P., ROUND ROCK, TX (US)

(72) Inventors: Lian LI, Beijing (CN); Ren WANG, Shanghai (CN); Cheng YANG, Beijing (CN); Yuhong NIE, Beijing (CN); Weiyang LIU, Shanghai (CN); Yun ZHANG, Shanghai (CN)

(21) Appl. No.: 18/789,340

(22) Filed: Jul. 30, 2024

(30) Foreign Application Priority Data
Jun. 7, 2024 (CN) 202410741077.8

(51) Int. Cl. G06F 8/65; G06F 8/41

(52) U.S. Cl. CPC G06F 8/65; G06F 8/427

(57) ABSTRACT

The present disclosure relates to a method, device, and computer program product for updating an application programming interface (API). The method includes identifying a code segment of a first version from the API. The method further includes converting the code segment of the first version to a first abstract syntax tree (AST) according to a first conversion strategy. The method further includes generating a second AST according to the first AST. The method further includes converting the second AST to a code segment of a second version according to a second conversion strategy. In scenarios where an API is automatically updated, the method according to the present disclosure can improve the accuracy of updating the API, thereby improving the efficiency of updating.

### TECHNICAL FIELD

The present disclosure relates to the field of computers and, more particularly, to a method, device, and computer program product for updating an API.

### BACKGROUND

It is often necessary to release application programming interfaces of new versions due to changes in user requirements, functional enhancements, or bug fixes. In the development and maintenance of application programming interfaces, the usual approach is to manually update the API code. The process is often time-consuming, labor-intensive, and error-prone, and manual updates require the intervention of specialized technicians, which increases human resource costs and may lead to service interruptions, which in turn affects the user experience.

There are also some automatic update services in the related art. For example, if a client starts an automatic update program at runtime, the program will first download an update list file on a server, and the file contains information such as the update file list, version, and time. In the event that an update is required, the update file is downloaded and the local file is overwritten.

### SUMMARY OF THE INVENTION

Embodiments of the present disclosure present a method, device, and computer program product for updating an API. In a first aspect of embodiments of the present disclosure, a method for updating an API is provided. The method includes identifying code segment of a first version from the API. The method further includes converting the code segment of the first version to a first abstract syntax tree (AST) according to a first conversion strategy. The method further includes generating a second AST according to the first AST. The method further includes converting the second AST to code segment of a second version according to a second conversion strategy.

In a second aspect of the embodiments of the present disclosure, an electronic device is provided. The electronic device includes one or more processors; and a storage apparatus for storing one or more programs, wherein the one or more programs, when executed by the one or more processors, cause the one or more processors to perform actions including identifying code segment of a first version from an API. The actions further include converting the code segment of the first version to a first abstract syntax tree (AST) according to a first conversion strategy. The actions further include generating a second AST according to the first AST. The actions further include converting the second AST to code segment of a second version according to a second conversion strategy.

In a third aspect of embodiments of the present disclosure, a computer program product is provided, which is tangibly stored on a non-volatile computer-readable medium and includes machine-executable instructions, wherein the machine-executable instructions, when executed, cause a machine to perform actions including identifying code segment of a first version from an API. The actions further include converting the code segment of the first version to a first abstract syntax tree (AST) according to a first conversion strategy. The actions further include generating a second AST according to the first AST. The actions further include converting the second AST to code segment of a second version according to a second conversion strategy.

It should be understood that the content described in the Summary of the Invention part is neither intended to limit key or essential features of the embodiments of the present disclosure, nor intended to limit the scope of the present disclosure. Other features of the present disclosure will become readily understood from the following descriptions.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 illustrates a schematic diagram of an example environment in which embodiments of the present disclosure can be implemented;

FIG. 2 illustrates a flow chart of a method for updating an API according to some embodiments of the present disclosure;

FIG. 3A illustrates a schematic diagram of the updating of an API according to embodiments of the present disclosure;

FIG. 3B illustrates a schematic diagram of the matching of code segments according to embodiments of the present disclosure;

FIG. 3C illustrates a schematic diagram of the training of a language converter 322 according to embodiments of the present disclosure;

FIG. 4 illustrates a schematic diagram of the identifying of a function code segment according to embodiments of the present disclosure;

FIG. 5 illustrates a schematic diagram of the matching of code segments according to embodiments of the present disclosure;

FIG. 6 illustrates a schematic diagram of an abstract syntax tree according to embodiments of the present disclosure;

FIG. 7 illustrates a schematic block diagram of an example device that can be used to implement embodiments of the present disclosure.

### DETAILED DESCRIPTION

Embodiments of the present disclosure will be described below in further detail with reference to the drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below.

In the related art, in some schemes for automatically updating an API, API code segments in different client devices contain unique characteristic information, which may be characteristic information formed by use of the API code segments by a user in the past history, and which may, for example, conform to the user's usage habits and facilitate the user's use. Directly overwriting these code segments of outdated versions with updated code segments may result in the loss of such characteristic information.

In addition, technical schemes that only use a neural network to predict code segment of an updated version (e.g., directly using a neural network to predict a code segment of an updated version) tend to be less accurate and depend only on the performance of the neural network itself, which leads to a greater randomness in the updating effect during each update, and thus makes them unsuitable for frequent updating needs and less stable.

The inventors of the present application have found, after research, that applying an abstract syntax tree dedicated to a code compilation process (e.g., for syntax checking, code style checking, code formatting, syntax highlighting, bug alerting, auto-completion, or the like) to a scenario of updating an API that is completely unrelated to the preceding scenarios can improve the accuracy and efficiency of code updating.

To this end, the present disclosure proposes a method for updating an API. The method of embodiments of the present disclosure includes identifying code segment of a first version from the API. The method further includes converting the code segment of the first version to a first AST according to a first conversion strategy. The method further includes generating a second AST according to the first AST. The method further includes converting the second AST to code segment of a second version according to a second conversion strategy. Instead of performing direct mapping between a code segment of an outdated version (i.e., the first version) and a code segment of an updated version (i.e., the second version) from the perspective of code segments, this method first abstracts syntactic information (including semantic and logical information) of the code segment of the outdated version by means of the abstract syntax tree, then performs mapping between the first AST and the second AST, and can thus automatically obtain the code segment of the updated version by restoring the second AST. By performing mapping at the level of syntactic information and since it is not interfered with by other irrelevant information (e.g., linguistic detail information), it is possible to improve the accuracy of automatic updating while still retaining the characteristic information of the user.

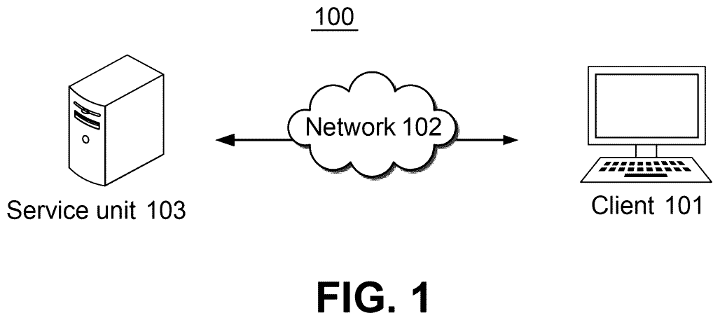

FIG. 1 illustrates a schematic diagram of an example environment 100 in which embodiments of the present disclosure can be implemented. As shown in FIG. 1, the environment 100 may include a client 101, a network 102, and a service unit 103, wherein the service unit 103 is communicatively coupled to the client 101 via the network 102. The network 102 may be, for example, a wide area network (WAN), a local area network (LAN), a wireless network, a public telephone network, an intranet, and any other type of network known to those skilled in the art.

In this embodiment, the method of updating an API is performed by the service unit 103. The method performed by the service unit 103 includes the following steps. The service unit 103 receives from the client 101 an API that needs to be updated and identifies a code segment of an outdated version from that API. The characteristic information in the client 101 that is formed during use may be kept in the API. The code segment of this outdated version may, for example, be a function code segment in the API that can be called.

The service unit 103 converts the code segment of the outdated version to a first AST according to a first conversion policy. In some embodiments, the service unit 103 may first perform lexical analysis on the code segment of the outdated version and segment the code segment of the outdated version into a series of meaningful symbols or tokens. These tokens include keywords, identifiers, operators, literal quantities (such as numbers and character strings), and punctuation marks. This may be implemented using a lexical analyzer or scanner, for example. In some embodiments, the service unit 103 may also perform syntactic analysis on the code segment of the outdated version, and convert the token sequence to an abstract syntax tree according to the syntactic rules (typically context-independent grammars) of the language. The matching of grammar rules is achieved using recursive functions, for example, by recursive descent parsing. In some embodiments, the service unit 103 may also construct a first AST based on lexical and syntactic analyses, wherein each node represents a construct in the source code, such as an expression, a declaration, a statement, or the like. The relationship between the nodes reflects the structure of the code segment of the outdated version.

After obtaining the first AST, the service unit 103 generates a second AST according to the first AST. In this operation, the service unit 103 performs mapping at the level of syntactic information, and since it is not interfered with by other irrelevant information, it is possible to improve the accuracy of the second AST while still retaining the history usage information of the user. The service unit 103 converts the second AST to a code segment of an updated version according to a second conversion strategy. The service unit 103 may implement the restoration of the second AST to a code segment, i.e., the code segment of the updated version, by means of the second conversion strategy.

In some embodiments, the service unit 103 is pre-deployed with a language converter. The service unit 103 traverses the first AST according to a first traversal strategy to obtain a first token sequence. The service unit 103 determines a second token sequence according to the first token sequence using a language converter. The service unit 103 traverses the second token sequence according to a reverse traversal strategy for the first traversal strategy to obtain the second AST.

As shown in FIG. 1, in the environment 100, the network 102 may be used to transmit data between the client 101 and the service unit 103. For example, the network 102 may be utilized to transmit the API from the client 101 to the service unit 103, and thus the service unit 103 can process this API according to embodiments of the present disclosure. The network 102 has a theoretical bandwidth. The theoretical bandwidth refers to a maximum transmission speed supported by the network 102, which indicates a maximum data amount that may be transmitted by the network 102 in an ideal condition, typically measured by the number of transmitted bits per second (bps). For example, if the theoretical bandwidth of the network 102 is 100 Mbps, it means that the network can transmit one hundred megabits of data per second under ideal conditions. In fact, however, due to other possible factors in the network (such as signal interference, bandwidth sharing, and transmission delay), the actual transmission speed may not reach 100 Mbps.

As understood by those skilled in the art, an example of the service unit 103 may be a stand-alone physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The server may be connected directly or indirectly through wired or wireless communication, which is not limited in the present application.

The client 101 may be any type of mobile computing device, including a mobile computer (e.g., a personal digital assistant (PDA), a laptop computer, a notebook computer, a tablet computer, a netbook, and the like), a mobile phone (e.g., a cellular phone, a smartphone, and the like), a wearable computing device (e.g., a smartwatch, a headset device, including smart glasses, and the like), or other types of mobile devices. In some embodiments, the client 101 may also be a fixed computing device, such as a desktop computer, a game machine, and a smart TV. It should be understood that in the case where the client 101 has sufficient computing power, the above operations may be performed by the client 101 instead of the service unit 103, and the above operations may also be performed by the client 101 and the service unit 103 together.

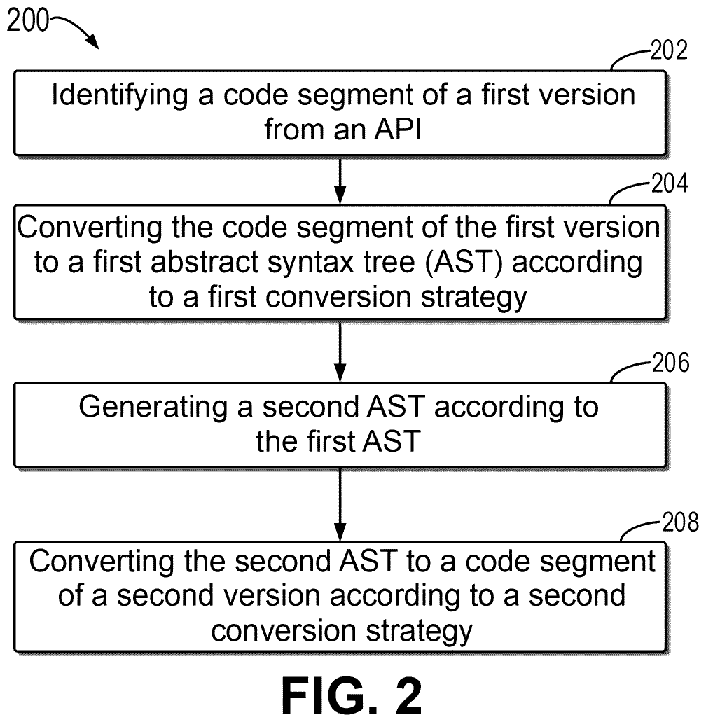

FIG. 2 illustrates a flow chart of a method for updating an API according to some embodiments of the present disclosure. As shown in FIG. 2, the flow chart 200 includes block 202-block 208. At block 202, a code segment of a first version is identified from the API. An application programming interface (API) is a set of rules or protocols that can support communication of software applications with each other, so as to exchange data, characteristics, and functionality. This API is an API used by a client device. The code segment of this first version, which is the code segment of the outdated version, is part of the API. In some embodiments, the code segment of the first version is a function code segment in the API that can be called by the API to complete specific functional operations. The code segment of this first version may be written in any programming language, such as an object-oriented programming language (e.g., C++ language) or a procedure-oriented programming language (e.g., C language).

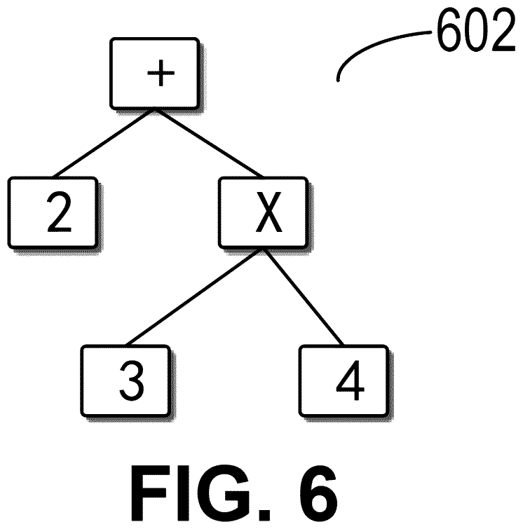

At block 204, the code segment of the first version is converted to a first AST according to a first conversion strategy. An abstract syntax tree (AST) is an abstract representation of a code syntax structure. It represents the syntax structure of a programming language in the form of a tree with each node in the tree representing a structure in the code. As with respect to FIG. 1, in some embodiments, the AST can be converted by operations such as lexical analysis, syntactic analysis, and the like. In the related art, there are various conversion strategies for converting an abstract syntax tree, and a suitable conversion strategy may be selected as the first conversion strategy according to the code features, and the present disclosure is not limited in this regard. FIG. 6 illustrates a schematic diagram of an abstract syntax tree according to embodiments of the present disclosure. As shown in FIG. 6, for the expression “2+3×4,” the abstract syntax tree shown in 602 can be obtained according to the first conversion strategy.

At block 206, a second AST is generated according to the first AST. The second AST is the AST corresponding to a code segment of the updated version (i.e., the second version). This operation performs mapping at the level of syntactic information, and since it is not interfered with by other irrelevant information, it is possible to improve the accuracy of the second AST while still retaining the history usage information of a user.

At block 208, the second AST is converted to a code segment of a second version according to a second conversion strategy. This second conversion strategy is a conversion strategy corresponding to the first conversion strategy and is used for parsing the AST and thus recovering the code segment. After obtaining the second AST, the code segment of the second (i.e., updated) version can be obtained by parsing the second AST according to the second conversion strategy. By replacing the code segment of the outdated version with the code segment of this updated version, an update of a portion of the code segment in the API can be realized.

Instead of performing direct mapping between a code segment of an outdated version (i.e., the first version) and a code segment of the updated version (i.e., the second version) from the perspective of code segments, the method according to embodiments of the present disclosure first abstracts syntactic information (including semantic and logical information) of the code segment of the outdated version by means of the abstract syntax tree, then performs mapping between the first AST and the second AST, and can thus automatically obtain the code segment of the updated version by restoring the second AST. By performing mapping at the level of syntactic information and since it is not interfered with by other irrelevant information (e.g., linguistic detail information), it is possible to improve the accuracy of automatic updating while still retaining the characteristic information of the user.

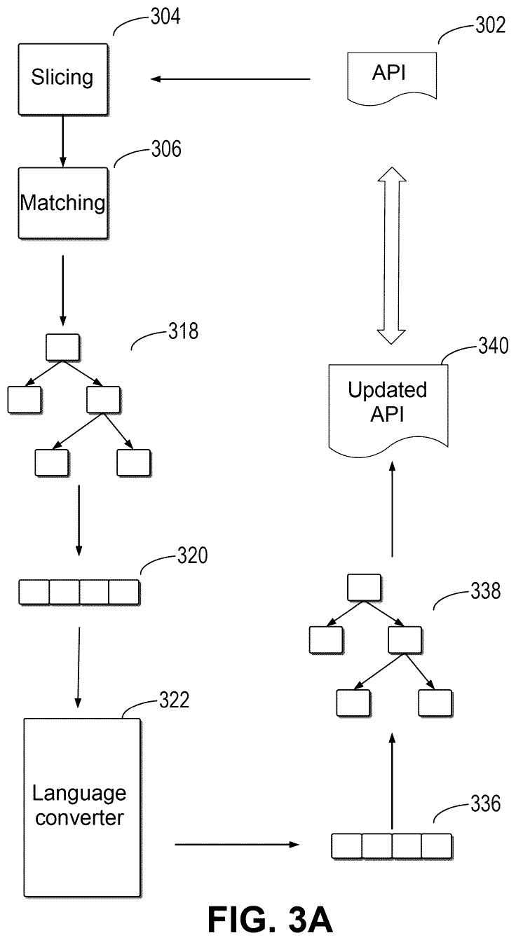

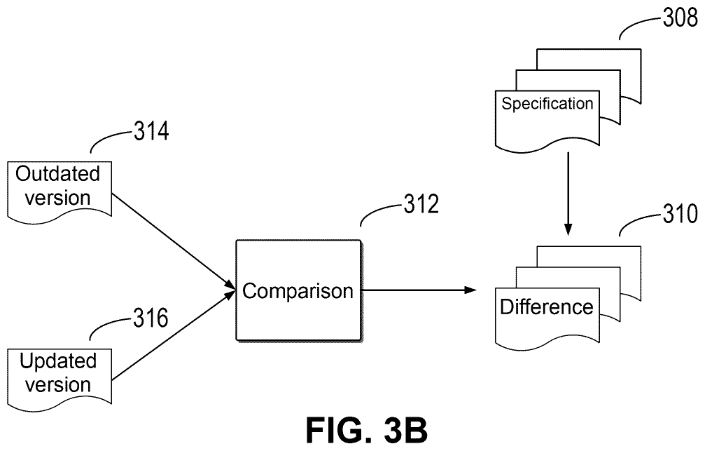

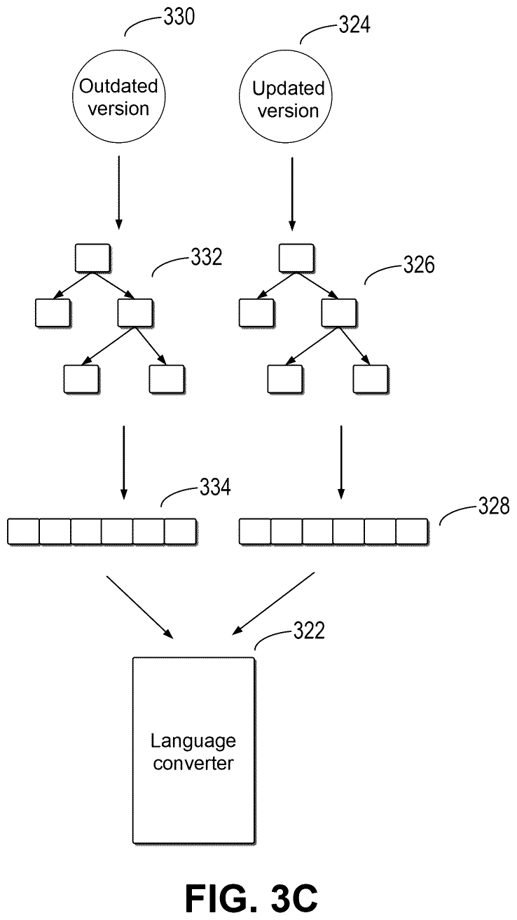

FIG. 3A illustrates a schematic diagram of the updating of an API according to embodiments of the present disclosure. As shown in FIG. 3, the API 302 contains code segments of outdated versions, for example, function code segments. To find out these code segments of outdated versions, the API undergoes slicing processing at 304. In some embodiments, the API is sliced to a plurality of code segments in accordance with a preset window. A degree of match between each of the code segments and a code segment of a second version is determined at 306.

FIG. 3B illustrates a schematic diagram of the matching of code segments according to embodiments of the present disclosure. A code segment of an outdated version at 314 is compared at 312 with a code segment of an updated version at 316 to obtain differences 310 between the two. Referring to the API specification at 308, it is determined whether these differences are differences introduced by version differences, and if so, the code segment at 314 is determined to be the code segment of the outdated version. For simplicity, if the degree of match between the code segment at 314 and the code segment of the second version is greater than a first threshold, the code segment is determined to be a code segment of an outdated version.

For identifying a code segment of an outdated version, in some alternative embodiments, a plurality of function code segments are identified from the API, wherein each of the function code segments includes at least one function. For example, functions in the API can be identified, and when a function code segment that can be called is found, this code segment can be determined as a function code segment. The plurality of function code segments identified are then detected. If the version of one code segment is outdated, the one code segment is determined as the code segment of the first version.

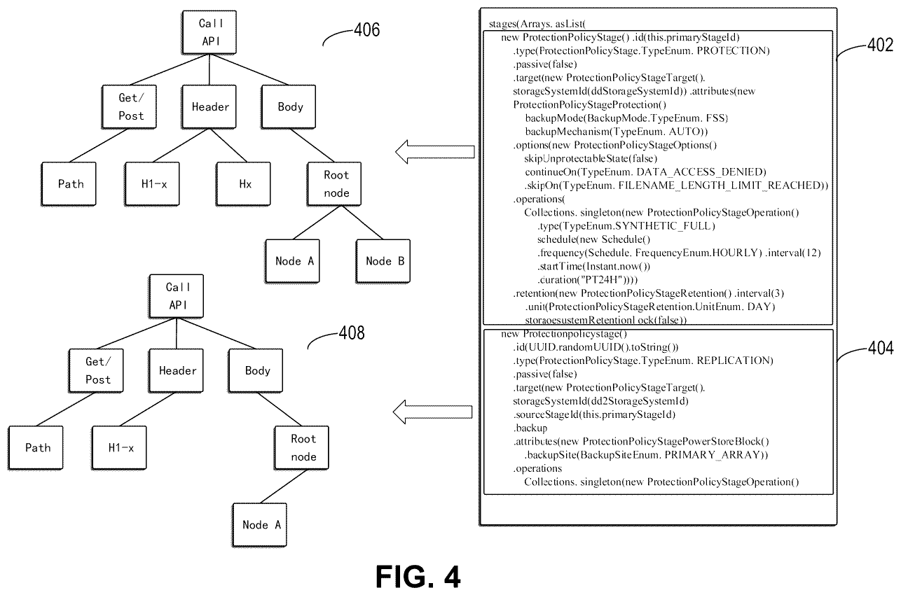

FIG. 4 illustrates a schematic diagram of the identifying of a function code segment according to embodiments of the present disclosure. Two function code segments, 402 and 404, are illustrated in the API section of FIG. 4. The first function code segment 402 is a code segment associated with the ProtectionPolicyStage( ) function having first id information, and the second function code segment 404 is a code segment associated with the ProtectionPolicyStage( ) function having second id information. Therefore, the keyword (e.g., “new”) used to define the function can be used to identify whether the related code segment is an independent function code segment. Code segment matching is performed for each of the function code segments to identify whether the function code segment is the one that needs to be updated. In the embodiment shown in FIG. 4, an AST 406 may be generated according to the function code segment 402. The root node of AST 406, “Call API,” indicates that the code segment is an API that can be called, and the content of the node “Get/Post” indicates the request method for this function code segment, wherein the Get request is used to acquire a certain resource on the server, and the Post request is used to submit data, such as form data, to the server for processing (e.g., storage, database updating, etc.) on the server. Sub-nodes of the node “Get/Post” indicate the path information related to the request. The content of the node “Header” indicates meta information about the request or response. Sub-nodes of the node “Header” indicate different meta information “H1-x” and “Hx.” The content of the node “Body” indicates the data content actually transmitted. For example, Body may contain form data, file upload data, and so on. In the embodiment shown in FIG. 4, an AST 408 may be generated according to the function code segment 404. The meanings of the nodes in AST 408 are similar to those of AST 406 and will not be repeated.

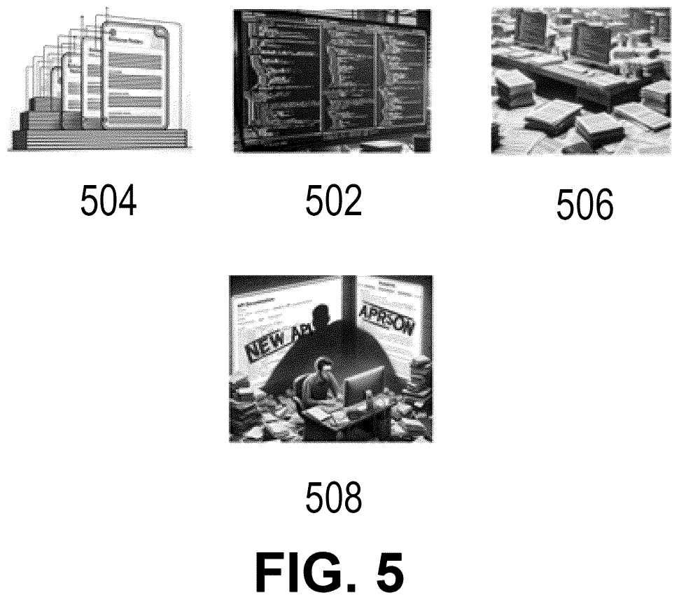

FIG. 5 illustrates a schematic diagram of the matching of code segments according to embodiments of the present disclosure. As shown in FIG. 5, after a difference 508 between a code segment of an outdated version (not shown) and a code segment 502 of an updated version of the API is obtained by means of comparison, a tester may refer to a code description 504 and a specification 506 related to the code segment 502 of the updated version, from which he/she can interpret whether the above difference 508 is the content that needs to be updated. The code description 504 explains the coding idea of each function or method, so the tester can refer to the code description 504 to see if the coding idea (which is structural information) of a certain function has changed. If a change has occurred, the code description 504 states which code lines have changed, which can thus be used to determine if the difference is structural information. The specification 506 describes the various requirements that the API needs to meet. If the specification 506 changes, it usually means that some of the function features in the API are adjusted accordingly. If the difference 508 corresponds to some changes in the specification 508, it means that this difference 508 is structural information and is the content that needs to be updated.

Referring back to FIG. 3A. After obtaining the code segment of the outdated version by means of matching at 306, the code segment of the first version is converted to a first AST 318 according to a first conversion strategy. At 320, the first AST 318 may be traversed according to the first traversal strategy to obtain a first token sequence 320. In some embodiments, the first abstract syntax tree is traversed by means of one of preorder traversing, inorder traversing, and postorder traversing.

Before performing mapping using a language converter 322, the language converter 322 is trained in advance. FIG. 3C illustrates a schematic diagram of the training of a language converter 322 according to embodiments of the present disclosure. During the training, a training code segment 330 of an outdated version and a training code segment 324 of an updated version are obtained. The training code segment 330 of this outdated version may be a code segment of the same version as the code segment of the outdated version obtained by means of matching in API 302, and the two may differ at code details (e.g., characteristic information). Similarly, the training code segment 324 of this updated version may be a code segment of the same version as the code segment of the updated version obtained by means of matching in API 302, and the two may differ at code details (e.g., characteristic information). At 332, the training code segment 330 of the outdated version is converted to a first training AST 332 according to the first conversion strategy. At 334, the first training AST 332 is traversed according to the first traversal strategy to obtain a first training token sequence 334. Similarly, the training code segment 324 of the updated version is converted to a second training AST 326 according to the first conversion strategy. At 328, the second training AST 326 is traversed according to the first traversal strategy to obtain a second training token sequence 328. Supervised training of the language converter 322 is performed using the first training token sequence 334 and the second training token sequence 328. During the training process, the parameters of each layer in the language converter 322 are randomly initialized, and then the first training token sequence 334 is input into the language converter 322 for forward propagation until a first prediction result is outputted. The second training token sequence 328 serves as a label of the first training token sequence 334, and a loss for this prediction is determined based on a loss function. For example, a cross-entropy loss function, a mean-square error loss function, a log-likelihood loss function, or the like may be selected. According to this loss, back propagation can be performed using a reverse gradient algorithm, thereby updating the parameters of each layer in the language converter. By continuously iterating the aforementioned training operations, the language converter 322 can be enabled to gradually acquire the capability of prediction between code segments of outdated versions and code segments of updated versions.

Referring back to FIG. 3A, a second token sequence 336 is determined according to the first token sequence 320 using the trained language converter 322, which embodies accurate structural information of the code segment of the updated version. The second token sequence 336 is traversed according to a reverse traversal strategy for the first traversal strategy to obtain a second AST 338. Based on this, the second AST 338 is converted to a code segment of an updated version according to the second conversion strategy, which is incorporated into the API to obtain an API 340 of an updated version. The API 340 of this updated version both updates part of the code of the API and retains the characteristic information of the client. Thus, an update to a code segment of the API can be accomplished by replacing the API 302 with the API 340 of the updated version. In some embodiments, the API 302 and the API 340 of the updated version may be written in different programming languages. For example, the API 302 is written in C++, an object-oriented programming language, while the API 340 is written utilizing C, a procedure-oriented programming language.

In some embodiments, it is possible to obtain not only the code segment of the updated version by means of the AST, but also a code segment of an intermediate version. In this embodiment, a third token sequence is determined according to the first token sequence using a language converter. In this embodiment, the third token sequence is traversed according to the reverse traversal strategy for the first traversal strategy to obtain a third AST. The third AST is converted to a code segment of a third version according to the second conversion strategy, wherein the third version is different from the second version.

In many cases, the user may not necessarily want to update the API to the latest version. For example, since the latest version of API is relatively not stable, the user may want to update the API to a code segment of a version that is between the first version and the second version. This embodiment provides the user with the capability of making such a choice.

During the training of the language converter, it should be trained using the training code segment of the third version in order to acquire richer mapping capabilities. In some embodiments, a training code segment of the third version is acquired. The training code segment of the third version is converted to a third training AST according to the first conversion strategy. The third training AST is traversed according to the first traversal strategy to obtain a third training token sequence. Supervised training of the language converter is performed using the first training token sequence and the third training token sequence, wherein the third training token sequence serves as a label of the first training token sequence. The third token sequence is predicted according to the first token sequence using the trained language converter. By performing the aforementioned training, the language converter can acquire the difference in structural information between the code segment of the first version and the code segment of the third version, thus achieving accurate updating.

In some embodiments, there is a plurality of code segments in the API that need to be updated, and if a version of another code segment in the plurality of code segments is also the first version, the another code segment is determined as the code segment of the first version after the conversion of the code segment of the second version, and by repeatedly implementing the previous embodiment, the code segments in the API that need to be updated are updated one by one.

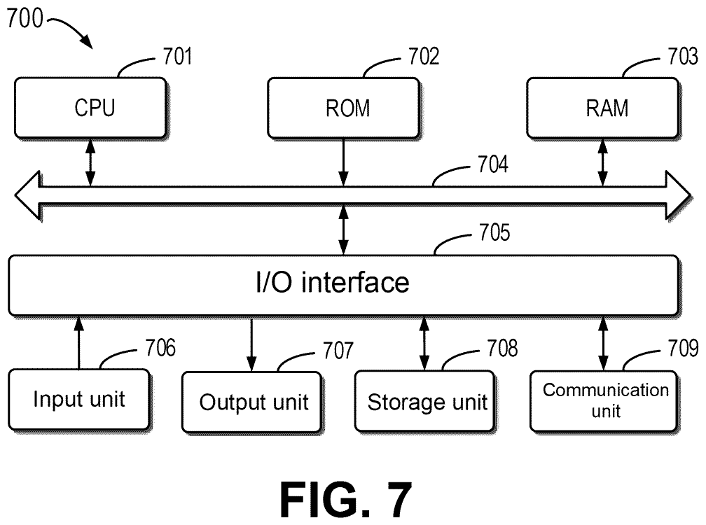

FIG. 7 is a schematic block diagram of an example device 700 that can be used to implement embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means for implementing the functions/acts specified in one or more blocks in the flow charts and/or block diagrams. These computer-readable program instructions may also be stored in a computer-readable storage medium, and these instructions cause a computer, a programmable data processing apparatus, and/or other devices to operate in a particular manner; and thus, the computer-readable medium storing instructions includes an article of manufacture that includes instructions implementing various aspects of the functions/actions specified in one or more blocks in the flow charts and/or block diagrams.

The computer-readable program instructions may also be loaded onto a computer, other programmable data processing apparatuses, or other devices, such that a series of operations or steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions annotated in the blocks may also occur in a sequence different from the sequence annotated in the figures. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed embodiments. Numerous modifications and alterations are apparent to those of ordinary skills in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed herein.

1. A method for updating an application programming interface (API), comprising:
identifying a code segment of a first version from the API;
converting the code segment of the first version to a first abstract syntax tree (AST) according to a first conversion strategy;
generating a second AST according to the first AST; and
converting the second AST to a code segment of a second version according to a second conversion strategy.

2. The method according to claim 1, wherein generating the second AST according to the first AST comprises:
traversing the first AST according to a first traversal strategy to obtain a first token sequence;
determining a second token sequence according to the first token sequence using a language converter; and
traversing the second token sequence according to a reverse traversal strategy for the first traversal strategy to obtain the second AST.

3. The method according to claim 2, wherein determining the second token sequence according to the first token sequence using the language converter comprises:
acquiring a training code segment of a first version and a training code segment of a second version;
converting the training code segment of the first version to a first training AST according to the first conversion strategy;
traversing the first training AST according to the first traversal strategy to obtain a first training token sequence;
converting the training code segment of the second version to a second training AST according to the first conversion strategy;
traversing the second training AST according to the first traversal strategy to obtain a second training token sequence;
performing supervised training of the language converter using the first training token sequence and the second training token sequence, wherein the second training token sequence serves as a label of the first training token sequence; and
predicting the second token sequence according to the first token sequence using the trained language converter.

4. The method according to claim 3, further comprising:
determining a third token sequence according to the first token sequence using the language converter;
traversing the third token sequence according to the reverse traversal strategy for the first traversal strategy to obtain a third AST; and
converting the third AST to a code segment of a third version according to the second conversion strategy, wherein the third version is different from the second version.

5. The method according to claim 4, wherein determining the third token sequence according to the first token sequence using the language converter comprises:
acquiring a training code segment of a third version;
converting the training code segment of the third version to a third training AST according to the first conversion strategy;
traversing the third training AST according to the first traversal strategy to obtain a third training token sequence;
performing supervised training of the language converter using the first training token sequence and the third training token sequence, wherein the third training token sequence serves as a label of the first training token sequence; and
predicting the third token sequence according to the first token sequence using the trained language converter.

6. The method according to claim 2, wherein traversing the first abstract syntax tree based on the first traversal strategy comprises:
traversing the first abstract syntax tree by means of one of preorder traversing, inorder traversing, and postorder traversing.

7. The method according to claim 2, wherein the API is written in a first programming language, the code segment of the second version is written in a second programming language, and the first programming language is different from the second programming language.

8. The method according to claim 1, wherein identifying the code segment of the first version from the API comprises:
slicing the API into a plurality of code segments in accordance with a preset window;
determining a degree of match between each of the code segments and the code segment of the second version; and
determining, in response to a degree of match between one code segment of the plurality of code segments and the code segment of the second version being greater than a first threshold, the one code segment as the code segment of the first version.

9. The method according to claim 1, wherein identifying the code segment of the first version from the API comprises:
identifying a plurality of function code segments from the API, wherein each of the function code segments comprises at least one function;
detecting the plurality of function code segments; and
determining, in response to a version of one code segment of the plurality of code segments being the first version, the one code segment as the code segment of the first version.

10. The method according to claim 9, further comprising:
determining, in response to a version of another code segment of the plurality of code segments being the first version, the another code segment as the code segment of the first version after the conversion of the code segment of the second version.

11. An electronic device, comprising:
at least one processor; and
coupled to the at least one processor and having instructions stored thereon, wherein the instructions, when executed by the at least one processor, cause the electronic device to perform following operations:
identifying a code segment of a first version from an API;
converting the code segment of the first version to a first abstract syntax tree (AST) according to a first conversion strategy;
generating a second AST according to the first AST; and
converting the second AST to a code segment of a second version according to a second conversion strategy.

12. The electronic device according to claim 11, wherein generating the second AST according to the first AST comprises:
traversing the first AST according to a first traversal strategy to obtain a first token sequence;
determining a second token sequence according to the first token sequence using a language converter; and
traversing the second token sequence according to a reverse traversal strategy for the first traversal strategy to obtain the second AST.

13. The electronic device according to claim 12, wherein determining the second token sequence according to the first token sequence using the language converter comprises:
acquiring a training code segment of a first version and a training code segment of a second version;
converting the training code segment of the first version to a first training AST according to the first conversion strategy;
traversing the first training AST according to the first traversal strategy to obtain a first training token sequence;
converting the training code segment of the second version to a second training AST according to the first conversion strategy;
traversing the second training AST according to the first traversal strategy to obtain a second training token sequence;
and the second training token sequence, wherein the second training token sequence serves as a label of the first training token sequence; and
predicting the second token sequence according to the first token sequence using the trained language converter.

14. The electronic device according to claim 13, wherein the operations further comprise:
determining a third token sequence according to the first token sequence using the language converter;
traversing the third token sequence according to the reverse traversal strategy for the first traversal strategy to obtain a third AST; and
converting the third AST to a code segment of a third version according to the second conversion strategy, wherein the third version is different from the second version.

15. The electronic device according to claim 14, wherein determining the third token sequence according to the first token sequence using the language converter comprises:
acquiring a training code segment of a third version;
converting the training code segment of the third version to a third training AST according to the first conversion strategy;
traversing the third training AST according to the first traversal strategy to obtain a third training token sequence;
and the third training token sequence, wherein the third training token sequence serves as a label of the first training token sequence; and
predicting the third token sequence according to the first token sequence using the trained language converter.

16. The electronic device according to claim 12, wherein traversing the first abstract syntax tree based on the first traversal strategy comprises:
traversing the first abstract syntax tree by means of one of preorder traversing, inorder traversing, and postorder traversing.

17. The electronic device according to claim 12, wherein the API is written in a first programming language, the code segment of the second version is written in a second programming language, and the first programming language is different from the second programming language.

18. The electronic device according to claim 11, wherein identifying the code segment of the first version from the API comprises:
slicing the API into a plurality of code segments in accordance with a preset window;
determining a degree of match between each of the code segments and the code segment of the second version; and
determining, in response to a degree of match between one code segment of the plurality of code segments and the code segment of the second version being greater than a first threshold, the one code segment as the code segment of the first version.

19. The electronic device according to claim 11, wherein identifying the code segment of the first version from the API comprises:
identifying a plurality of function code segments from the API, wherein each of the function code segments comprises at least one function;
detecting the plurality of function code segments; and
determining, in response to a version of one code segment of the plurality of code segments being the first version, the one code segment as the code segment of the first version.

20. A computer program product, the computer program product being tangibly stored on a non-volatile computer-readable medium and comprising machine-executable instructions, wherein the machine-executable instructions, when executed by a machine, cause the machine to perform following operations:
identifying code segment of a first version from an API;
converting the code segment of the first version to a first abstract syntax tree (AST) according to a first conversion strategy;
generating a second AST according to the first AST; and
converting the second AST to code segment of a second version according to a second conversion strategy.
